(19) United States
(12) Patent Application Publication
(10) Pub. No.: US 2009/0313894 A1
(43) Pub. Date: Dec. 24, 2009

(54) AIR PUMPED NUTRIENT FLUID HYDROPONIC GROWING AND AERATING SYSTEM

(76) Inventor: Reb Bieber, El Dorado Hills, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/489,433

(22) Filed: Jun. 23, 2009

Related U.S. Application Data
(60) Provisional application No. 61/074,727, filed on Jun. 23, 2008.

(51) Int. Cl. A01G 31/00; H01M 10/46

(52) U.S. Cl. 47/62 R; 320/101

(57) ABSTRACT

A hydroponic growing system utilizes a single air pump to pressurize a sealed nutrient container, where a water-based nutrient fluid is initially forced up a nutrient coupling to a hydroponic planter growing bed. After the nutrient fluid from the sealed nutrient container falls below an input of the nutrient coupling, air from the air pump continues to bubble up through the fluid coupling, thereby oxygenating both the nutrient fluid and the more highly elevated hydroponic planter growing bed. After a controlled frequency and duration of air pump activation, the air pump is deactivated, whereupon the nutrient fluid drains back to the lower elevation sealed nutrient container by gravity. A small orifice acts to depressurize the otherwise sealed nutrient container, allowing the return of the nutrient fluid. The extremely modest energy requirements of the system easily allow off-grid operation using photovoltaic cells charging rechargeable batteries that power the system.

### CROSS-REFERENCE TO RELATED APPLICATIONS

This application claims priority from U.S. provisional application Ser. No. 61/074,727 filed on Jun. 23, 2008, incorporated herein by reference in its entirety.

### STATEMENT REGARDING FEDERALLY SPONSORED RESEARCH OR DEVELOPMENT

Not Applicable

### BACKGROUND OF THE INVENTION

1. Field of the Invention

This invention pertains generally to hydroponic plant growing, more particularly to hydroponic plant growing systems with oxygenated nutrient solutions, and still more particularly to a hydroponic plant growing system with oxygenated nutrient solutions with no more than a single pump per hydroponic planter providing both the oxygenation and flow of the nutrient fluid.

2. Description of Related Art

Traditional hydroponic growing systems appear to use a plurality of pumps to circulate nutrient fluids among the root systems, and still more pumps to oxygenate the nutrient fluid so that the nutrient fluids may more closely resemble the growing conditions of plants in traditional dirt growth media. Such resulting hydroponic systems tend to be complex, costly, inefficient, and cumbersome.

### BRIEF SUMMARY OF THE INVENTION

An aspect of the invention is a hydroponic growing system, which may comprise: a hydroponic planter; and means for pumping a nutrient fluid to the hydroponic planter. The nutrient fluid is generally predominantly water, but will generally have additional nutrients and micronutrients suitable for plant growth. The means for pumping may comprise a sealed nutrient container that contains at least some of the nutrient fluid; a fluid coupling between the hydroponic planter and the sealed nutrient container; and an air pump fluidly coupled to the sealed nutrient container through an air coupling, whereby the sealed nutrient container nutrient fluid becomes pressurized upon activation of the air pump; wherein the pressurized nutrient fluid is initially forced through the fluid coupling to the hydroponic planter. The fluid coupling is generally a hose or tube, but may be otherwise hard plumbed so as to fluidly connect the hydroponic planter and the sealed nutrient container.

In the system above, the air pump is the only pump present. This single pump implementation tends to reduce energy consumption and increase the system simplicity and efficiency. The corresponding increase in efficiency allows for off-grid operation with very low energy costs, as may be supplied with photovoltaic cells. With the single pump, air is subsequently forced through the fluid coupling to the hydroponic planter after the nutrient fluid has reached a sufficiently low level in the sealed nutrient container, thereafter oxygenating the nutrient fluid in the hydroponic planter.

A timer may be used to control a frequency and duration of activation of the air pump described above. The timer and air pump above may be powered by a battery. These frequencies and durations may be the same or different depending on the growth requirements of a particular plant or crop. Additionally, the frequencies and durations may be preprogrammed into the timer/controller so as to match the growing requirements of the particular species of plants to be grown in the particular system.

In the system above, a photovoltaic panel may be connected to the battery, wherein the battery is recharged upon a sufficient light flux incident upon the photovoltaic panel. Alternatively, a recharger capable of connecting to a local alternating current power system may be used to recharge the battery.

The air pump may be either alternating current (AC) or direct current (DC) powered. Similarly, the timer may also be AC or DC powered. Should either the air pump or the timer require AC, then an inverter may be disposed between the batter and the air pump, wherein the inverter converts the battery direct current (DC) into alternating current (AC) suitable for the air pump or timer, as required.

In the hydroponic growing system described above, the sealed nutrient container is disposed at a lower elevation than the hydroponic planter. In this case, the nutrient fluid returns from the hydroponic planter to the sealed nutrient container through the fluid coupling when the sealed nutrient container supply fluid is no longer pressurized. This return is achieved through simple hydraulic flow due to different heights of the hydroponic planter and the sealed nutrient container.

However, if the sealed nutrient container is completely sealed except for the fluid coupling and the air coupling, then the air pumped through the air coupling would pressurize the sealed nutrient container to an extent where there would be no substantial return flow of the nutrient fluid back into the sealed nutrient container, and the pressure in the sealed container would equal that of the hydraulic head in the fluid coupling. For this reason, a small orifice is introduced to allow for the slow depressurization of the sealed nutrient container. This small orifice may be disposed on the sealed nutrient container, the portion of the fluid coupling that enters the sealed nutrient container (allowing pressurized air to escape through the fluid coupling to the hydroponic planter), or in the air coupling (external to the sealed nutrient container, so as to release the air to ambient pressure). Should the air pump be sufficient leaky, an orifice may not be needed, as the backflow through the air pump may provide a sufficient depressurization rate.

In an embodiment where a cap seals the sealed nutrient container, with both the air coupling and fluid coupling passing through the cap, an orifice may be introduced into the cap.

By orifice, as used above, it is meant that there is an opening allowing some small percentage of the air pump flow to escape from the pressurized air space within the sealed nutrient container.

Another aspect of the invention is a method of periodically supplying a nutrient fluid to a hydroponic planter, and thereafter aerating the nutrient fluid in the hydroponic planter, comprising: providing a hydroponic planter; and means for pumping a nutrient fluid to the hydroponic planter.

This method may additionally comprise: pressurizing a sealed nutrient container with an air pump, so as to initially force to the hydroponic planter a nutrient fluid stored within the sealed nutrient container; and after at least some of the nutrient fluid has been pumped to the hydroponic planter, then pumping air to the hydroponic planter; and after a period of time pumping air to the hydroponic planter, turning off the air pump, thereby allowing nutrient fluid previously pumped to the hydroponic planter to return to the sealed nutrient container through a nutrient coupling. This return of the nutrient fluid from the hydroponic planter to the sealed nutrient container occurs due to a hydraulic head generated by the hydroponic planter being higher than the sealed nutrient container.

Alternatively stated, a method of supplying a nutrient fluid and air to a hydroponic planter, may comprise: providing a container with a nutrient fluid therein; coupling the container to a hydroponic planter with a fluid coupling; pressurizing the container with air to initially force the nutrient fluid through the fluid coupling to the hydroponic planter; after at least some of the nutrient fluid has been forced to the hydroponic planter, forcing air through the fluid coupling to the hydroponic planter; and after a period of time wherein air is forced to the hydroponic planter, depressurizing the container to allow excess nutrient fluid previously forced to the hydroponic planter to return to the container through the fluid coupling.

The method above may further comprise controlling a frequency and duration of the pressurizing step with a timer. Here, at least some of the nutrient fluid previously forced to the hydroponic planter returns to the container under the force of gravity through the fluid coupling.

The method above may further comprise pressuring the container with a single electrically powered air pump.

This method may also comprise recharging a rechargeable battery used to power the air pump. Further, the method may also comprise controlling the frequency and duration of the pressurizing step with a timer.

In the method described above, the rechargeable battery may be selected from a group of rechargeable batteries consisting of: a flooded lead acid batter, a gel-cell battery, an absorbed glass mat (AGM) battery, a Ni-Cad batter, a nickel-metal-hydride (NiMH) battery, a rechargeable alkaline battery.

The method above may further comprise recharging the rechargeable battery with a photovoltaic cell.

The method above may be rendered into a hydroponic aeration apparatus, capable of performing the steps described above.

In the method above, the means for pumping may comprise providing regulated air from a compressed air source. Ultimately, such compressed air source may originate from a container of pressurized air, a large scale compressor capable of simultaneously supplying air to one or more of the hydroponic systems described herein. The air pump may be powered by a power source selected from a group of power sources consisting of: direct current (DC) electricity, alternating current (AC) electricity, a mechanical displacement, and a mechanical rotation.

In the method above, depressurizing the sealed nutrient container may be achieved by using an orifice disposed thereupon. Alternatively, depressurizing the sealed nutrient container may be achieved by allowing pressurized air within the sealed nutrient container to return through an orifice disposed on the fluid coupling within the sealed nutrient container, or an orifice disposed on the air coupling, or a leak disposed within the air pump.

A still further aspect of the invention is an integrated hydroponic aeration system, comprising: an integrated assembly, comprising: an air pump chamber that houses an air pump; a sealed nutrient container that may hold a nutrient fluid, wherein the sealed nutrient container may be selectively pressurized by the air pump; a hydroponic planter fluidly connected to the sealed nutrient container by a nutrient coupling.

In the integrated hydroponic aeration system above, within the integrated assembly, the hydroponic planter is disposed at a higher elevation than the sealed nutrient container. This higher elevation of the hydroponic planter allows for the gravity drain-back of the nutrient fluid after the termination of a feeding cycle.

In all of the systems described above, aeration, and hence oxygenation of the nutrient fluid may be accomplished by extending the air coupling into the sealed nutrient container, and terminating the air coupling in a bubbler. In this manner, air pumped by the air pump will bubble through the nutrient fluid prior to or simultaneously with forcing of the nutrient fluid toward the hydroponic planter.

In still another embodiment, the bubbler may be disposed below a terminus of the nutrient coupling within the sealed nutrient container. In this embodiment, oxygenation through the bubbling action occurs while the nutrient fluid is pumped to the hydroponic planter.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a perspective diagram of an air-pressure fed hydroponic growing system, where a low pressure air pump is used to replace evaporation losses in the hydroponic nutrient bed, and to aerate the nutrient fluid in the nutrient bed.

FIG. 2 is a perspective drawing of one implementation of the air-pressure fed hydroponic growing system of FIG. 1.

FIG. 3 is a detailed perspective view of a sealed nutrient container, showing the entrance and egress of air and fluid couplings, and an air pressure exit orifice.

FIG. 4 is a perspective drawing of one implementation of a single air-pumped air-pressure fed hydroponic system of FIG. 1 being used with a plenum to instead feed several hydroponic planters by using several of the sealed nutrient containers of FIG. 3.

FIG. 5 is a perspective view of an integrated hydroponic system similar in function to the system of FIG. 1, however, the side walls of the structure form the hydroponic planter and sides of accessed bins containing the sealed nutrient container below the air pump.

FIG. 6 is a perspective view of a larger scale version of an integrated hydroponic system, with the air pump and sealed nutrient supply laterally spaced apart, perhaps more suited to nursery growing scales.

FIG. 7 is a perspective view of a larger scale version of an integrated hydroponic system, with an air pump external to the sealed nutrient supply, perhaps suited to home garden growing scales.

FIG. 8 is a perspective view of a still larger scale version of an integrated hydroponic system mounted on rail cars, with one or more modified flat cars for growing, and a tanker car supplying nutrient fluid or water to make up for evaporative losses.

FIG. 9 is a perspective view of an attractively packaged implementation of an integrated hydroponic system, suitable for patio, indoor, or other low cost applications.

FIGS. 10A-10D are perspective views of variations on the sealed nutrient container of FIG. 3 where direct oxygenation of the nutrient fluid is achieved prior to pumping to the hydroponic planter.

### DETAILED DESCRIPTION OF THE INVENTION

### Definitions

The following terms are used herein and are thus defined to assist in understanding the description of the invention(s). Those having skill in the art will understand that these terms are not immutably defined and that the terms should be interpreted using not only the following definitions but variations thereof as appropriate within the context of the invention(s).

“Nutrient fluid” means any dissolved or suspended element or compound suspended in a substantially water medium.

“Hose” means a hollow tube designed to carry fluids from one location to another. Hoses, as used herein, include tubes or pipes (pipe usually refers to a rigid tube) whereas the hose is usually flexible, or more generally tubing. The shape of a hose is usually, but not necessarily, cylindrical (having a circular cross section).

“Air coupling” means a hose that passes air.

“Fluid coupling” means a hose that passes both nutrient fluid and air.

### DESCRIPTION OF PREFERRED EMBODIMENTS

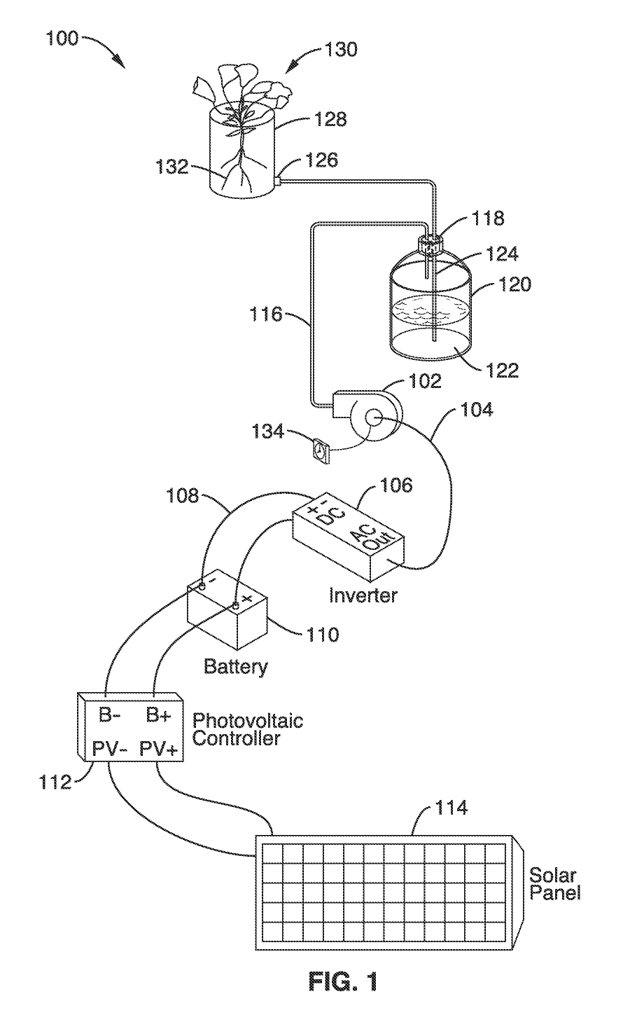

Referring more specifically to the drawings, for illustrative purposes the present invention is embodied in the apparatus generally shown in FIG. 1 through FIG. 10D. It will be appreciated that the apparatus may vary as to configuration and as to details of the parts, and that the method may vary as to the specific steps and sequence, without departing from the basic concepts as disclosed herein.

The present invention pertains to a hydroponic growing system that appears to have very high efficiency, sufficient to use low power photovoltaic or other relatively low power sources for operation.

Refer now to FIG. 1, which is a diagram of a single pump nutrient feed and aeration system 100. Here, an air compressor 102 is electrically connected 104 to a power source 106. Here, power source 106 is shown as an inverter, but other power sources are possible, such as direct current (DC) battery power, DC solar power, or others. The inverter 106 is in turn electrically connected 108 to one or more rechargeable storage batteries 110.

These storage batteries 110 are nominally 12 V, but may be at other voltages as designed or desired. One application would be to use deep cycle lead-acid storage batteries 110, although maintenance free, Absorbed Glass Mat (AGM), or gel-cell batteries may also be used.

If one desired to depart from the lead-acid storage batteries, lithium, nickel-metal-hydride, or other more expensive power storage devices could be used.

Regardless of the type of storage battery 110, ultimately the battery 110 would require replenishment or recharging of energy used to power the inverter 106, or the air pump 102 (if directly connected to the air pump 102).

Such recharging of the storage battery 110 could readily be accomplished through the use of a photovoltaic controller 112 powered by an appropriate solar panel 114. Depending on the design of the photovoltaic panel 114, a photovoltaic controller 112 may not be required and a simple blocking diode (not shown) may be used to prevent drains by the photovoltaic panel 114 at night. The blocking diode may also be incorporated within the solar panel 114.

Finally, for indoor systems, or systems close to electrical power sources, a direct recharging of the storage battery 110 may be used via typical residential electrical plugs (not shown here).

An air hose 116 may be used to connect the air compressor 102 to a nutrient storage fitting 118. This nutrient storage fitting 118 allows a substantially pressure-tight fitting with nutrient storage container 120. Within the nutrient storage container 120 is a nutrient solution 122. The nutrient solution 122 comprises water, with the nutrients required for successful plant growth.

The nutrient solution 122 is forced through a nutrient tube 124 that passes through the nutrient storage fitting 118, and ultimately passes through a waterproof fitting 126 in a hydroponic planter 128 where plants 130 may be grown.

Within the hydroponic planter 128, an inert rooting medium (not shown) allows mechanical attachment for plant roots 132.

During operation, the air compressor 102 supplies a pressurized air supply to air hose 116, which in turn pressurizes the interior of the nutrient storage container 120. This pressurized air, in turn, forces the nutrient solution 122 through the nutrient tube 124 towards the hydroponic planter 128. The nutrient solution 122 is pumped until the level of the nutrient solution 122 in the nutrient storage container 120 lies below the inlet terminus of the nutrient tube 124 within the nutrient storage container 120.

When this low level of nutrient solution 122 is reached, the pressurized air within the nutrient storage container 120 is forced through the nutrient tube 124 to the hydroponic planter 128, where the plant roots 132 are oxygenated through the bubbles of forced air. In a small hydroponic planter, it appears that full oxygenation of the nutrient solution (now almost completely residing in the hydroponic planter 128) occurs in about 15 minutes of bubbling.

The bubbling, which occurs within the nutrient tube 124 and within the nutrient solution now resident in the hydroponic planter 128, is due to the hydrostatic pressure of the nutrient solution as it attempts to return to the nutrient storage container 120 through the nutrient tube 124. Clearly, for this to successfully function, the nutrient storage container 120 must be below the hydraulic grade line of the hydroponic planter 128.

After a period of activation of the air compressor 102 (typically about 15 minutes, depending on the size of the hydroponic planter 128 and the flow rate and volume of nutrient solution originally present in the nutrient storage container 120), the air pump or compressor 102 is stopped via a timer controller 134. With no continuing pressure being applied to the interior of the nutrient storage container 120, nutrient solution flows from the hydroponic planter 128 through the nutrient tube 124 back to the nutrient storage container 120. When completed, most of the nutrient solution has returned to the nutrient storage container 120, except for a residual wetted amount remaining in the hydroponic planter 128 on the plant roots 132 and inert growing medium.

With the return of most of the nutrient solution, the plant roots 132 have atmospheric air drawn into their interstitial spaces, allowing even more oxygenation of the roots 132. Oxygenation of the roots is important, since oxygen prevents growth of anaerobic bacteria, which may otherwise rot the plant roots 132.

The cycle of filling the hydroponic planter 128 and draining the nutrient solution back to the nutrient storage container 120 may be repeated as desired in frequency and duration for optimal plant 130 growth.

In an indoor growing environment, the photovoltaic panel 114 may be incorporated into a hood of a growing light (not shown) providing the electricity needed to charge the storage battery and operate the air pump 102 and timer controller 134. This would “recycle” some amount of the cost of the high powered growing light. In other words, if the photovoltaic panel is closely disposed adjacent to the growing light, then there should be sufficient light energy absorbed so that the photovoltaic cell electricity may be produced for charging or operating the system, when typically growing occurs in large scale green houses. Electricity is less expensive in low demand times of the day, which are typically night and evening.

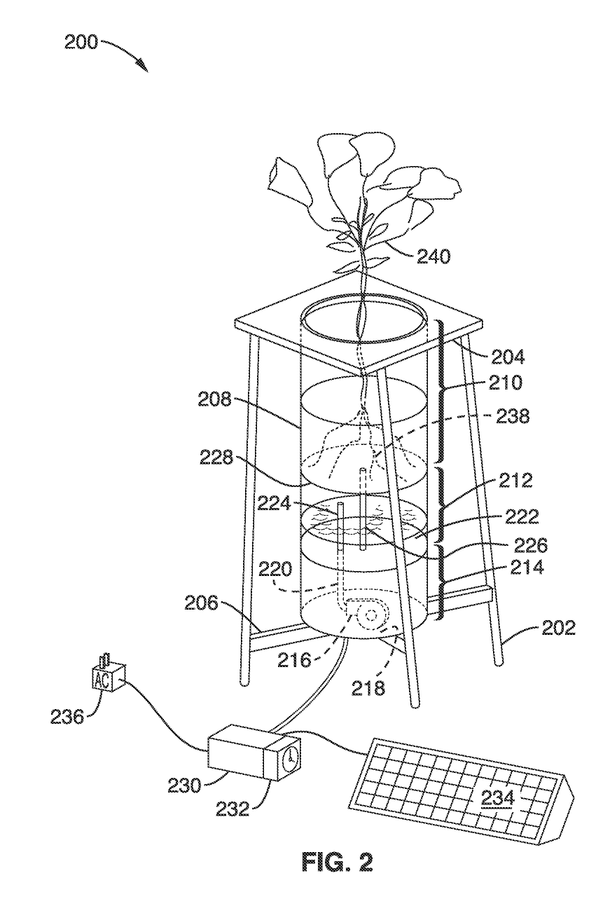

Refer now to FIG. 2, which is a drawing of one seemingly elegant implementation 200 of the schematic of FIG. 1. Here, wooden (or other suitable structural material) legs 202 attach at a top platform 204 and are interconnected with cross braces 206. The interconnected cross braces 206 support an integrated nutrient hydroponic planter 208 that is steadied by a clearance hole in the top platform 204.

The integrated hydroponic planter 208 comprises a cylindrical tube with three major regions. A topmost region 210 where plant roots may grow, a nutrient storage region 212, where the growing nutrient is stored, and an air compressor region 214, where an air compressor or pump 216 resides. A base 218 allows for mounting of the air compressor 216. The base 218 may be either fixed, or removable. If removable, the base 218 would allow for replacement or repair of the air compressor or pump 216.

Air compressor or pump 216 has an output tube 220 that passes from the output of the air compressor or pump 216 through a lower seal 222 to the nutrient storage region 212, terminating 224 near the top. A nutrient tube 226 projects down from an upper seal 228 (forming a waterproof bottom of the topmost region 210) until it nearly reaches the bottom of the nutrient storage region 212, allowing fluid connection between the nutrient storage region 212 and the topmost region 210.

It should be noted that the topmost region 210, the nutrient storage region 212, and the air compressor region 214 are shown as if they were transparent in this FIG. 2 drawing. Should the topmost region 210 and nutrient storage region 212 actually be transparent, inadvertent algae growth would be problematic. Therefore, at least the topmost region 210 and the nutrient storage region 212 should be optically opaque. This opacity then forestalls the algae growth problem.

During use, the air compressor or pump 216, which may be a typical aquarium pump or other more powerful pump, may be powered by an electrical connection to a rechargeable battery 230, which may have a timer controller 232 to control the operational times and durations of the air compressor or pump 216. The rechargeable battery 230 may in turn be recharged either by a photovoltaic cell 234, or a wall charger 236. The air compressor or pump 216 supplies pressurized air to the output tube 220, which in turn pressurizes the nutrient storage region 212. This pressurization of the nutrient storage region 212 forces nutrient solution up through the nutrient tube 226 and into the topmost region 210 where roots 238 of the plant (or plants) 240 is growing.

After a sufficient time of operation of the air compressor or pump 216, the nutrient solution has largely been moved from the nutrient storage region 212 to the topmost region 210, and the air supplied by the air compressor 216 continues to bubble up through the nutrient tube 226 into the topmost region 210 and the plant 240 roots 238. This continued air bubbling allows for thorough oxygenation of the nutrient solution.

For an integrated hydroponic system 200 of this size, early estimates are that the air compressor 216 should be run about 15 minutes to fully oxygenate the nutrient solution in the plant 240 roots 238. It also appears that five (5) of these cycles daily appear sufficient for thriving plant 240 growth. Horticultural testing is continuing with a goal of optimizing and further verifying these cycle parameters.

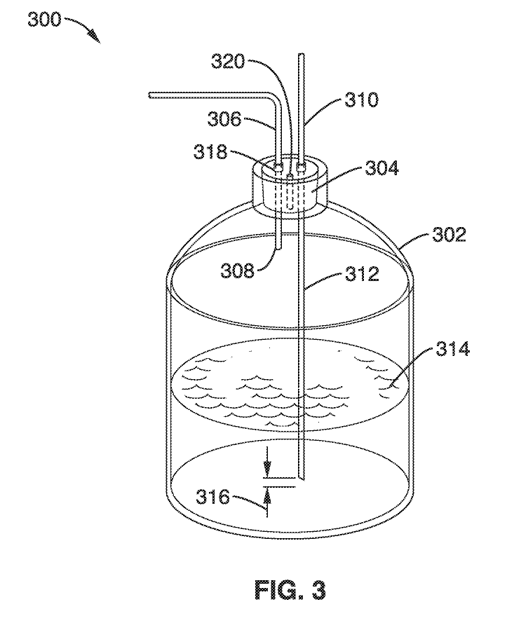

Refer now to FIG. 3, which is an enlarged perspective view of a typical sealed nutrient container 300. Here, a container 302 is sealed by a cap 304. The cap may be either press fit or screwed onto the container 302, so long as an air-tight fit is obtained between the cap 304 and the container 302. Into the cap 304 passes an air coupling 306, which then passes through the cap 304 to the inside 308 of the container 302. Container 302 is typically opaque, thereby forestalling any algae growth problems.

In this FIG. 3, the air coupling 306 is a tube or hose that passes through the cap 304, although other air-tight connections are readily obtained, such as a tube connection to a rigid pipe passed partially or completely through the cap 304. Such a rigid pipe may be plastic, glass, metal, or some other functionally equivalent material.

Similarly, a fluid coupling 310 passes through the cap 304 extending for a longer distance 312 below the cap 304. This longer distance 312 lowers below the resting level of nutrient fluid 314, to a distance 316 typically very close to the bottom of the container 302. Typical close distances may range from ½ to 3 diameters of the fluid coupling 310, and may range from 1-20 mm.

It should be noted that either or both of the air coupling 306 and the fluid coupling 310 may, instead of being passed directly through the cap 304, may instead be passed through sealed feed throughs 318.

In operation, the cap 304, the container 302, the air coupling 306 and the fluid coupling 310 are sealed so that a pressure generated at the air coupling 306 results in nutrient fluid 314 being passed upward through the fluid coupling 310 with no loss of air from the environs of the container 302.

However, if there is no air loss in the system above, then when the air coupling 306 is no longer pressurized, nutrient fluid 314 will only partially drain back (presuming that the fluid coupling 310 terminus is above the container 302) until the container 302 is pressurized to an amount equal to the hydraulic head of the nutrient fluid 314. Thus, an orifice 320 is added to pass through the cap 304.

The orifice 320 is sufficiently small that the nutrient fluid 314 is still mostly pumped by the air coupling 306 into the fluid coupling 310, with some small proportion of the pumped air from the air coupling 306 exiting the orifice 320. Then, when the pumping time is concluded, the nutrient fluid 314 passes back to the container 302, displacing air above the nutrient fluid 312 level through the orifice 320.

Although the orifice 320 is shown here in the cap 304, it may reside in the fluid coupling 312 within the container 302 (thereby venting the air through the fluid coupling 310), in the air coupling 306 exterior to the container 302, or disposed separately on the container 302 above the nutrient fluid 314 nominal filling level.

While an orifice 320 is the simplest implementation, a check valve (not shown) may replace the orifice 320, where air is allowed to exit, but nutrient fluid 314 is not. Such a replacement of the orifice 320 would preclude spillage of nutrient fluid 314 in the event of the container 302 turning over with the cap 304 in place.

Still another functionally equivalent replacement of the orifice 320 would be to use Gore-Tex® fabric, where air and water vapor are allowed exit due to the micro-porosity of the material, but liquid (which is mostly water) nutrient fluid 314 is not allowed to exit.

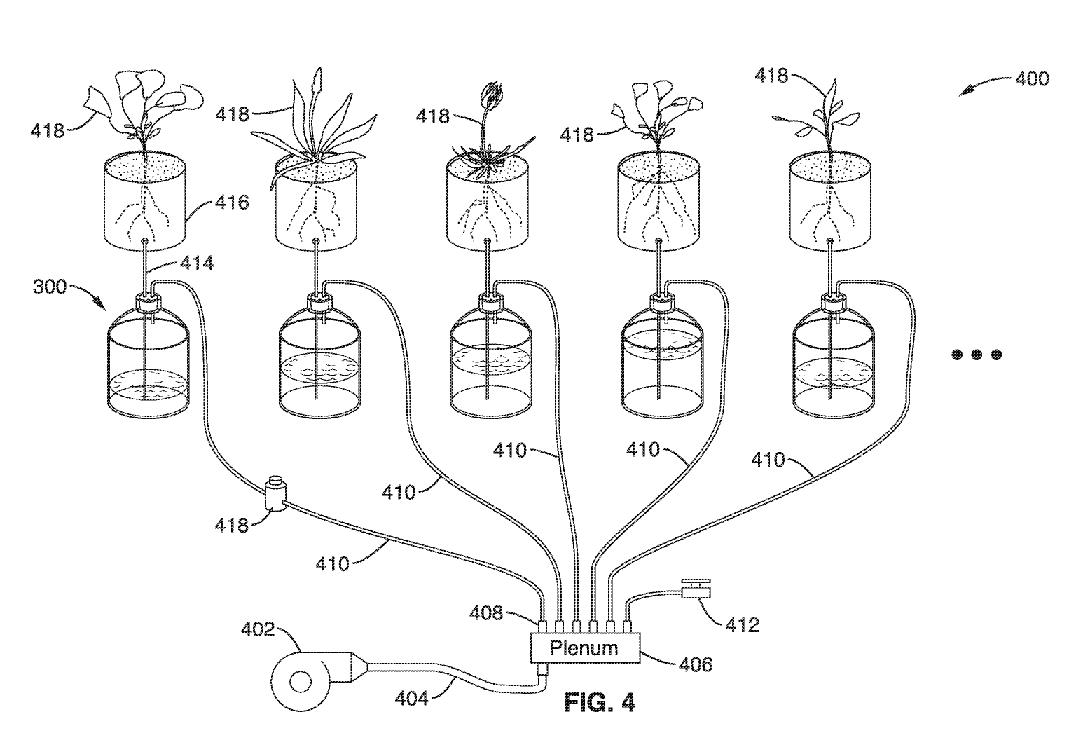

Refer now to FIG. 4, which is one implementation 400 of a single air-pumped 402 air-pressure fed hydroponic system of FIG. 1 being used with a plenum to instead feed several hydroponic planters by using several of the sealed nutrient containers 300 of FIG. 3. Here, a single air pump 402 is fluidly connected 404 to a plenum 406. The individual hose connections 408 on the plenum 406 may be traditional air pressure quick disconnects, or may simply be nipples upon which vinyl air hose is pressed upon. Air couplings 410 may include additional valves 412 to terminate or regulate flow in the air couplings 410, or may pass directly to the individual sealed nutrient containers 300 previously described in FIG. 3.

From the individual sealed nutrient containers 300, nutrient fluid is fed through nutrient couplings 414 to hydroponic planters 416, where individual or groups of plants 418 are grown.

One benefit of this FIG. 4 system is that different nutrient fluid may be used depending on the plant to be grown. Thus, if tomatoes are to be grown, one nutrient fluid may be use, however, if rice is to be grown, another nutrient fluid may be used.

Additionally, even though hydroponic planters and sealed nutrient containers are indicated in the FIG. 4 as the same size, they need not be. That is, the individual hydroponic planter and sealed nutrient containers 300 may be sized as sets, allowing the single air pump 402 to be used to hydroponically grow crops in greatly varying sizes of hydroponic planters 416.

Further, air regulators 418 may be introduced into the air couplings 410 to properly regulate the pressure applied to the variously sized sealed nutrient containers 300 further accommodating hydroponic planter 416 of greatly varying sizes.

For the sake of clarity, the timer, which controls the frequency and duration of powering the air pump 402, has been omitted from the FIG. 4, as has the power source for the air pump 402. These would be similar in nature to those previously shown in FIG. 1.

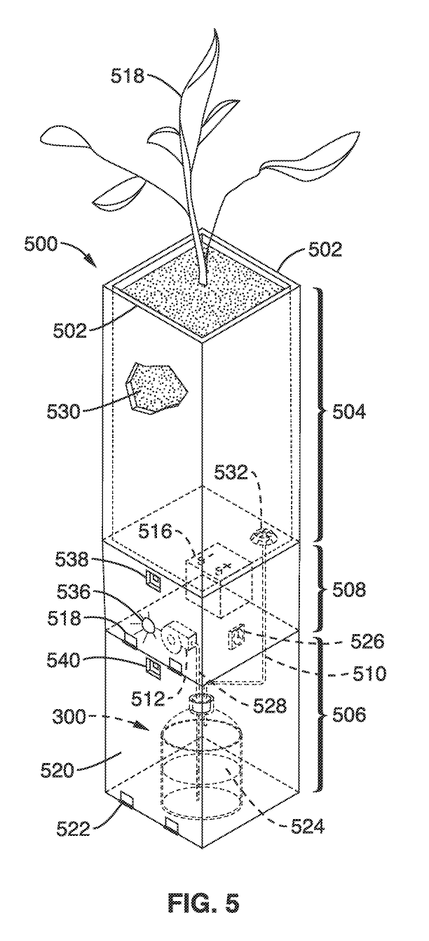

Refer now to FIG. 5, which is another variation 500 of the single pump hydroponic system of FIG. 1. Here, the walls 502 form a square or rectangular cross section, thereby forming both the structural support and hydroponic planter 504 section of the system. A sealed nutrient container 300 previously described in FIG. 3 is stored in a lower section 506 of the hydroponic system 500. A middle section 508 is formed for the routing of the air coupling 510 between the air pump 512 and the sealed nutrient container 300.

An air pump 512 access door 514 allows access to the air pump 512 and its battery (or other) power source 516. One or more hinges 518 allow for the opening and closing of the access door 514. Similarly, a nutrient access door 520 is allowed by one or more second hinges 522, allowing access to filling and checking the nutrient level 524 in the sealed nutrient container 300.

Operation in this implementation is similar to the previous embodiments. Here, a timer 526 controls the frequency and duration of pump 512 activation. When activated, the air pump 512 forces pressurized air down the air tube 528, thereby pressurizing nutrient container 300, and forcing nutrient solution 524 up the nutrient tube 510 to exit and flow into the hydroponic planter 504 inert growing medium 530. The junction 532 between the nutrient tube 510 and the hydroponic planter 504 is water tight, preventing nutrient solution from otherwise flooding the middle section 508 air pump 512 and other components. An inverted strainer or other mesh 534 sits atop the junction 532 preventing the growing medium 530 from passing into and clogging the nutrient tube 510.

Finally, operational indicators 536 provide a status of operation (air pumping or not) or nutrient solution levels. These operational indicators 536 may connect to the timer 526, or other sensors capable of detecting nutrient solution level in the nutrient container 300. Access to either the air pump 512 or sealed nutrient container 300 is by operation of latches 538 or 540, respectively.

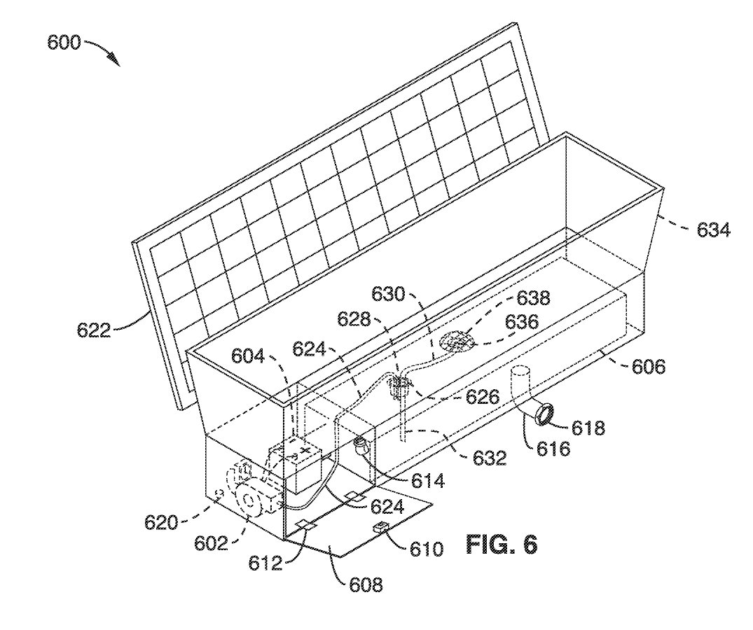

Refer now to FIG. 6, which is a larger scale version 600 of an integrated hydroponic system, with the air pump 602 battery 604 and sealed nutrient supply 606 laterally spaced apart. An access door 608 is secured with a latch mechanism 610, where the door 608 pivots about hinges 612. Fill port 614 allows for filling of the sealed nutrient container 606, which is of a generalized rectilinear shape in this embodiment. The shape of the sealed nutrient container 606 may comprise a sloping region (not shown) to a lowest point drained by a drain line 616, which may be sealed with a drain plug 618.

Between the fill port 614 and the drain line 616, the sealed nutrient container 606 may readily be filled or drained, respectively, through the use of the access door 608 and opening of the drain plug 618.

The access door 608 also allows repair or maintenance access to the air pump 602, battery 604, or other electronics (not shown). An external wall plug 620 allows for the powering of the integrated hydroponic system 600. For off-grid operation, one or more photovoltaic panels 622 may be used to power the air pump 602 directly, or to recharge the battery 604, depending on the particular options desired.

In operation, the air pump 602 flows air through air coupling 624 to a cap 626 with a pressure release orifice 628 as described above to allow for drain back of the nutrient fluid after air pump 602 activation has been concluded. The air coupling 624 pressurizes the sealed nutrient container 606, thereby forcing nutrient fluid up the nutrient coupling 630, which extends 632 to a relatively low point in the sealed nutrient container 606.

The nutrient coupling 630 continues to the hydroponic planter 634 through a leak tight connection 636 in the base of the hydroponic planter 634. The leak tight connection 636 is covered with a mesh, screen, or strainer 638 so as to keep hydroponic growth medium (not shown here for clarity) in the hydroponic planter 634 from flowing into and potentially clogging the nutrient coupling 630.

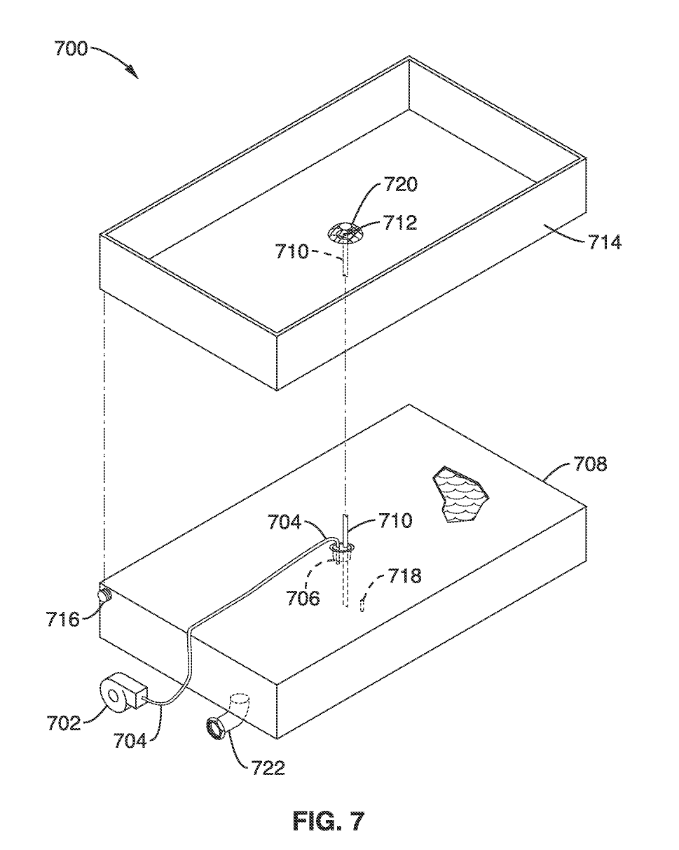

Refer now to FIG. 7, which is a separable large-scale hydroponic planter system of the present invention 700. Here, an external air source 702 (which is shown here as an air pump, but it may also be an external air compressor with or without pressure regulation), periodically flows air through an air coupling 704 to a cap 706 that seals a rectangular nutrient container 708. Nutrient coupling 710 descends through the cap 706 to nearly the bottom of the nutrient container 708, and passes through the cap 706 to terminate 712 in the hydroponic planter 714.

The rectangular nutrient container 708 may be filled either by the cap 706, or by an exterior fill cap 716. As previously discussed, small air orifice 718 vents the sealed rectangular nutrient container 708, thereby allowing for nutrient fluid to pass from the hydroponic planter 714, through a strainer or mesh 720 (so as to exclude the inert growing medium in the hydroponic planter 714 from the nutrient coupling 710), and finally return to the rectangular nutrient container 708. Here, the small air orifice 718 is shown on the body of the rectangular nutrient container 708, although it could also be disposed on the cap 706. Again, the small air orifice 718 allows for the nutrient fluid to return to the rectangular nutrient container 708 by gravity return. Finally, a drain port 722 is disposed near the lowest point of the rectangular nutrient container 708, allowing for draining of the nutrient fluid as needed.

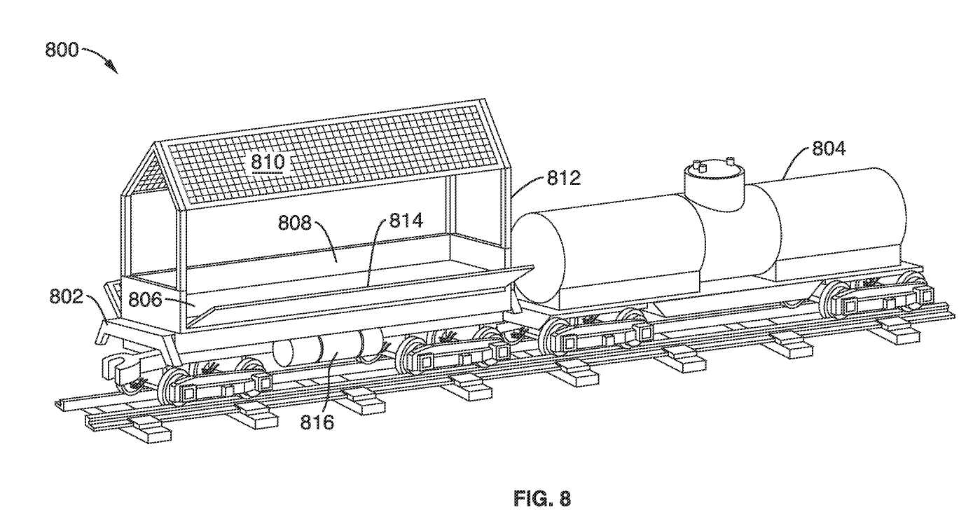

Refer now to FIG. 8, where we find a railroad embodiment of the single pump hydroponic system invention 800. Here, one or more modified flat cars 802 obtain either direct nutrient fluid, or refilling of evaporative losses from the tanker car 804. A lower section 806 of the modified flat car 802 contains an air pump (not shown) and any power storage systems, such as rechargeable batteries (also not shown). A hydroponic planter 808 lies above the lower section 806, where inert growing medium (not shown) and growing plants (not shown) reside.

Since the plants may be sensitive to too much sunlight, mesh sun screens 810 are supported 812 above the hydroponic planter 808. Foldable photovoltaic panels 814 pivot down from the sides of the modified flat car 802 to obtain power for the air pump in the lower section 806.

In some embodiments, either all, or a limited amount of nutrient fluid may be stored in a tank 816 suspended below the modified flat car 802. However, greater flexibility and scale may be obtained by using the separate tanker car 804 with a plurality of modified flat cars 802 supplied by the single tanker car 804 to make up for evaporative losses in the various modified flat cars 802.

Further, in some embodiments, antitheft measures (not shown) are emplaced about the modified flat car 802 so that at night, theft is deterred.

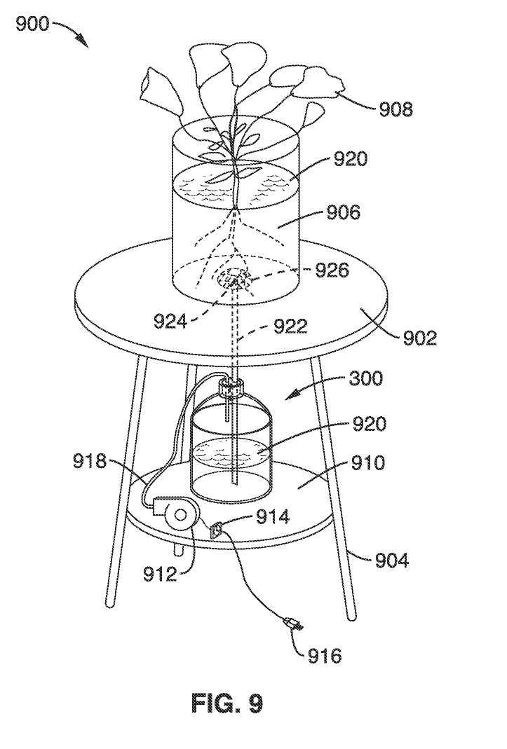

Refer now to FIG. 9, which is a rather attractively packaged implementation 900 of the invention, suitable for patio, sun deck, indoor, or low cost applications. Here, a circular table 902 supported by three or more legs 904, in turn supports a hydroponic planter 906 whereupon one or more plants 908 may be grown. A lower platform 910 attaches to at least some of the legs 904. The lower platform 910 in turn supports the sealed nutrient container 300 previously described in FIG. 3. The lower platform 910 also may support the air pump 912 and timer/controller 914. Power may be at lowest cost (if connected to an electrical grid) connected 916 to residential AC power.

Here, the air pump 912 is activated by the timer/controller 914, and powered by the AC power connection 916 (or other suitable power source as described above). The air pump 912 pressurizes the sealed nutrient container 300 through the air coupling 918. Once pressurized, the sealed nutrient container flows nutrient fluid 920 through fluid coupling 922, through the circular table 902 into a sealed connection 924 in the base of the hydroponic planter 906. The sealed connection 924 is in turn covered by an inverted strainer 926 or other mesh (not shown) so as to prevent the clogging of the fluid coupling 922 by hydroponic growing substrate (not shown) that allows plant 908 roots to mechanically attach.

Operation is similar to previous descriptions above, with nutrient fluid 920 periodically being pumped by air pump 912 to the hydroponic planter 906, additional air is pumped by the air pump 912 to oxygenate the roots, and the nutrient fluid flows back to the sealed nutrient container 300 via gravity induced drain-back.

Should the plant 908 be of a carnivorous species, additional food sources may be directly supplied to the plant in addition to the nutrient fluid 920.

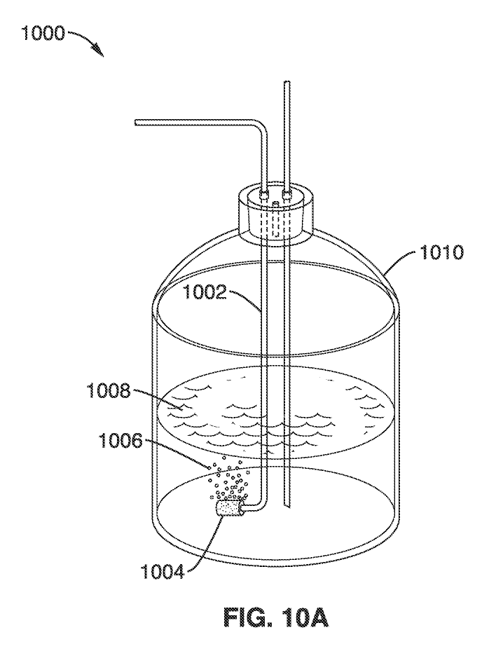

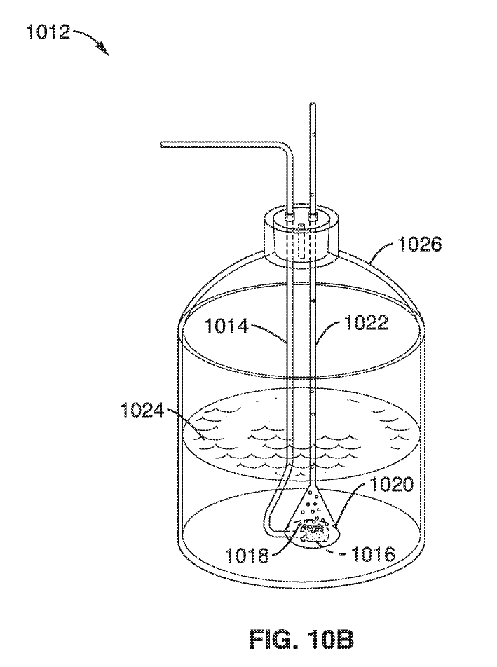

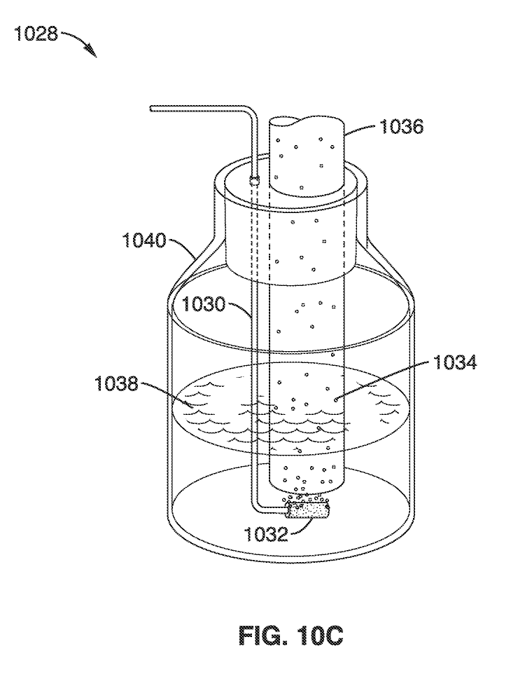

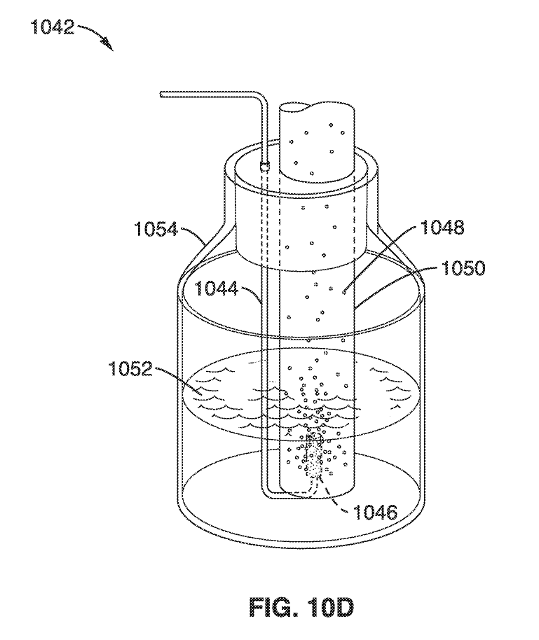

Refer now to FIGS. 10A through 10D, which are various methods of oxygenating the nutrient fluid in the sealed nutrient container previously described in FIG. 3.

FIG. 10A shows an apparatus 1000 where the nutrient fluid is directly oxygenated by the air coupling. Here, the air coupling 1002 passes through to a bubbler 1004, which, when operational, produces air bubbles 1006, thereby aerating the nutrient fluid 1008 in the sealed nutrient container 1010.

FIG. 10B shows an apparatus 1012 where the nutrient fluid is directly oxygenated by the air coupling throughout the length of the nutrient coupling. Here, the air coupling 1014 passes through to a bubbler 1016, which, when operational, produces air bubbles 1018 that are captured by an inverted funnel 1020, which funnels the air bubbles 1018 throughout the length of the fluid coupling 1022, thereby aerating the nutrient fluid 1024 as it passes out of the sealed nutrient container 1026 to a hydroponic planter.

FIG. 10C shows an apparatus 1028 where the nutrient fluid is directly oxygenated by the air coupling throughout the length of the nutrient coupling. Here, the air coupling 1030 passes through to a bubbler 1032, which, when operational, produces air bubbles 1034 that are captured by an enlarged fluid coupling 1036, which transports the air bubbles 1034 throughout the length of the fluid coupling 1036, thereby aerating the nutrient fluid 1038 as it passes out of the sealed nutrient container 1040 to a hydroponic planter.

FIG. 10D shows an apparatus 1042 where the nutrient fluid is directly oxygenated by the air coupling throughout the length of the nutrient coupling. Here, the air coupling 1044 passes through to a bubbler 1046, which, when operational, produces air bubbles 1048 that are captured by an enlarged fluid coupling 1050, which transports the air bubbles 1048 throughout the length of the fluid coupling 1050, thereby aerating the nutrient fluid 1052 as it passes out of the sealed nutrient container 1054 to a hydroponic planter.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A hydroponic growing system, comprising:
a hydroponic planter; and
means for pumping a nutrient fluid to the hydroponic planter.

2. The hydroponic growing system of claim 1, wherein the means for pumping comprises:
a sealed nutrient container that contains at least some of the nutrient fluid;
a fluid coupling disposed between the hydroponic planter and the sealed nutrient container; and
an air pump fluidly coupled to the sealed nutrient container through an air coupling, whereby the sealed nutrient container nutrient fluid becomes pressurized upon activation of the air pump;
wherein the pressurized nutrient fluid is initially forced through the fluid coupling to the hydroponic planter.

3. The hydroponic growing system of claim 2, wherein the air pump is the only pump present.

4. The hydroponic growing system of claim 2, wherein air is forced through the fluid coupling to the hydroponic planter after the nutrient fluid has reached a sufficiently low level in the sealed nutrient container, thereafter oxygenating the nutrient fluid in the hydroponic planter.

5. The hydroponic growing system of claim 4, further comprising a timer that controls a frequency and duration of activation of the air pump.

6. The hydroponic growing system of claim 5, further comprising a battery that supplies power to the timer and air pump.

7. The hydroponic growing system of claim 6, further comprising:
a photovoltaic panel connected to the battery;
wherein the battery is recharged upon a sufficient light flux incident upon the photovoltaic panel.

8. The hydroponic growing system of claim 7, further comprising:
a recharger capable of connecting to a local alternating current power system;
wherein the recharger is capable of recharging the battery.

9. The hydroponic growing system of claim 6, further comprising:
an inverter disposed between the battery and the air pump;
wherein the inverter converts the battery direct current (DC) into alternating current (AC) suitable for the air pump.

10. The hydroponic growing system of claim 2, wherein the sealed nutrient container is disposed at a lower elevation than the hydroponic planter.

11. The hydroponic growing system of claim 2, wherein the nutrient fluid returns from the hydroponic planter to the sealed nutrient container through the fluid coupling when the sealed nutrient container supply fluid is no longer pressurized.

12. A method of supplying a nutrient fluid and air to a hydroponic planter, comprising:
providing a container with a nutrient fluid therein;
coupling the container to a hydroponic planter with a fluid coupling;
pressurizing the container with air to initially force the nutrient fluid through the fluid coupling to the hydroponic planter;
after at least some of the nutrient fluid has been forced to the hydroponic planter, forcing air through the fluid coupling to the hydroponic planter; and
after a period of time wherein air is forced to the hydroponic planter, depressurizing the container to allow excess nutrient fluid previously forced to the hydroponic planter to return to the container through the fluid coupling.

13. The method of claim 12, further comprising controlling a frequency and duration of the pressurizing step with a timer.

14. The method of claim 12, wherein at least some of the nutrient fluid previously forced to the hydroponic planter returns to the container under the force of gravity.

15. The method of claim 12, further comprising pressuring the container with a single electrically powered air pump.

16. The method of claim 15, further comprising powering the air pump with a rechargeable battery selected from a group of rechargeable batteries consisting of a flooded lead acid battery, a gel-cell battery, an absorbed glass mat (AGM) battery, a Ni-Cad battery, a nickel-metal-hydride (NiMH) battery, and a rechargeable alkaline battery.

17. The method of claim 16, further comprising recharging the rechargeable battery with a photovoltaic cell.

18. The method of claim 12, further comprising pressurizing the container with an air pump powered by a power source selected from a group of power sources consisting of direct current (DC) electricity, alternating current (AC) electricity, a mechanical displacement, and a mechanical rotation.

19. The method of claim 12, further comprising depressurizing the container with an orifice exposed to the pressurization therein and to an external ambient pressure.

20. The method of claim 12, further comprising depressurizing the container by allowing pressurized air within the container to return through an orifice disposed on the fluid coupling.

21. An integrated hydroponic aeration system, comprising:
an integrated assembly, comprising:
an air pump chamber that houses an air pump;
a sealed nutrient container that may hold a nutrient fluid, wherein the sealed nutrient container may be selectively pressurized by the air pump; and
a hydroponic planter fluidly connected to the sealed nutrient container by a nutrient coupling.

22. The integrated hydroponic aeration system of claim 21, wherein, within the integrated assembly, the hydroponic planter is disposed at a higher elevation than the sealed nutrient container.
